(19) United States
(12) Patent Application Publication
(10) Pub. No.: US 2023/0348252 A1
(43) Pub. Date: Nov. 2, 2023

(54) BOTTLE OPENER, METHOD OF FABRICATING AND USING SAME

(71) Applicant: Itzhak GVISHI, Kiryat-Tivon (IL)

(72) Inventor: Itzhak GVISHI, Kiryat-Tivon (IL)

(21) Appl. No.: 17/734,078

(22) Filed: May 1, 2022

(51) Int. Cl. B67B 7/16; B65B 69/00

(52) U.S. Cl. CPC B67B 7/16; B65B 69/00

(57) ABSTRACT

A bottle opener is disclosed which comprises at least two outwardly facing bottle-opening structures being connected to one another with at least one rigid connecting element, the at least two outwardly facing bottle-opening structures being on different, non-parallel planes. Methods of using same and constructing same are also disclosed.

### FIELD AND BACKGROUND OF THE INVENTION

The present invention, in some embodiments thereof, relates to a bottle opener, methods of fabricating same and using same for opening at least two bottles concurrently, in opposing directions.

Bottle openers can come in a variety of shapes and sizes and are used for the removal of bottle caps from bottles. Typically, a bottle opener utilizes a lever, wherein the load is inserted under the lip of a bottle cap and a fulcrum is placed over the top of a bottle cap. When the user applies an upward effort on the lever, the load will pull the bottle cap up so that it pivots around the fulcrum to open the bottle.

Background art includes U.S. Design Pat. No. D62639351, www(dot)patents(dot)google(dot)com/patent/US D626393S1/en, U.S. Pat. No. 9,120,659, U.S. Patent Application Publication No. 20110296955 and U.S. Patent Application Publication No. 20180170735. Additional background art is found in www(dot)youtube(dot)com/watch?v=F6h1cyGNpPQ and www(dot)imprintitems(dot)com/product/twoway-fidget-spinner-bottle-opener.

### SUMMARY OF THE INVENTION

According to an aspect of the present invention, there is provided a bottle opener comprising at least two outwardly facing bottle-opening structures being connected to one another with at least one rigid connecting element, the outwardly facing bottle-opening structures being on different, non-parallel planes, wherein:
(a) the bottle opener comprise two outwardly facing, opposing bottle-opening structures and the different, non-parallel planes intersect at a predetermined angle between 50-85 degrees; and/or
(b) the at least two bottle opening structures are identical; and/or
(c) the bottle opener having mirror symmetry about its vertical and horizontal axis; and/or
(d) the bottle opener configured for substantially simultaneously removing crown caps from at least two hand-held glass bottles; and/or;
(e) each of the outwardly facing opening structures is designed for removing crown caps.

According to embodiments of the invention, the bottle opener is configured for substantially simultaneously removing crown caps from two hand-held glass bottles.

According to embodiments of the invention, the removing is hands-free removing.

According to embodiments of the invention, the bottle opening structures comprise an aperture.

According to embodiments of the invention, the rigid connecting element comprises a friction element.

According to embodiments of the invention, a horizontal distance between a distal end of a first opening structure of the two opposing outwardly facing bottle-opening structures and a distal end of a second opening structure of the two opposing outwardly facing bottle-opening structures is between 3 cm and 30 cm.

According to embodiments of the invention, the bottle opener is a dual bottle opener comprising two opposing outwardly facing bottle-opening structures and a single rigid connecting element.

According to embodiments of the invention, the bottle opener is configured for being operable concurrently by two users, wherein a first of the two users removes a crown cap from a first of the two glass bottles and a second of the two users substantially simultaneously removes a crown cap from a second of the two glass bottles, whereby the two users need not directly touch the dual bottle opener.

According to embodiments of the invention, the connecting element comprises a bend.

According to embodiments of the invention, the connecting element is V shaped or U shaped.

According to embodiments of the invention, the connecting element is an open U shaped.

According to embodiments of the invention, the connecting element:
(i) comprises a bend;
(ii) is V shaped or U shaped;
(iii) is an open U shape; or
(iv) is a closed ring shape.

According to embodiments of the invention, each of the bottle-opening structures form a fulcrum at one end thereof and a prying lip at the opposite end thereof.

According to embodiments of the invention, the fulcrum of a first bottle-opening structure of the two outwardly facing bottle-opening structures and a fulcrum of a second bottle-opening structure of the two outwardly facing bottle-opening structures is positioned at the distal ends of the connecting element.

According to embodiments of the invention, the at least two outwardly facing bottle-opening structures are integrally formed with the at least one rigid connecting element.

According to embodiments of the invention, the at least two outwardly facing bottle-opening structures are connectable to the at least one rigid connecting element.

According to embodiments of the invention, each of the at least two outwardly facing bottle-opening structures form a part of a bottle opener which further comprises a lever, the lever acceptable into a receptacle formed in or on the at least one rigid connecting element.

According to embodiments of the invention, the different planes are selected such that when a bottom of the first bottle is pivoted upwardly, the fulcrum of the first notch engages, and extends partially across, the top surface of the first crown cap and when a bottom of the second bottle is pivoted upwardly, the fulcrum of the second notch engages, and extends partially across, the top surface of the cap of the second bottle According to embodiments of the invention, the bottle opener is fabricated from metal.

According to embodiments of the invention, the bottle opener is fabricated from plastic.

According to embodiments of the invention, the connecting element has a promotional branding surface portion configured to receive at least one of (i) an image, and (ii) a design component.

According to embodiments of the invention, the prying lip is rounded.

According to embodiments of the invention, the prying lip is serrated.

According to embodiments of the invention, the bottle opener is formed by at least one of a stamping process, a casting process, a forging process, a machining process, an additive manufacturing process, or any combination thereof.

According to an aspect of the present invention, there is provided a method of opening two bottles comprising:
(a) placing the two opposing outwardly facing bottle-opening structures of the bottle opener provided herein under the bottle crown-cap of the two bottles; and
(b) lifting the bottom of the two bottles substantially simultaneously in an upwards direction so as to engage the bottle-opening structure with the top of the bottle crown cap, thereby opening the two bottles.

According to embodiments of the invention, a first user lifts the bottom of the first of the two bottles and a second user lifts the bottom of the second of the two bottles.

According to an aspect of the present invention, there is provided a method of fabricating a bottle opener, comprising:
(a) cutting or stamping apertures in a metal body to generate the at least two bottle opening structures; and
(b) bending the metal body such that the bottle opening structures are on different, non-parallel planes.

According to an aspect of the present invention, there is provided a rigid curved connecting element which can be used to combine two bottle openers to generate a dual bottle opener comprising two opposing bottle-opening structures, the opposing bottle-opening structures being on different, non-parallel planes.

According to an aspect of the present invention, there is provided a kit comprising the rigid curved connecting element described herein and two bottle openers configured to be attached to the rigid curved connecting element.

According to an aspect of the present invention there is provided a bottle opener for substantially simultaneously removing crown caps from at least two hand-held bottles, the opener comprising a first closed structure having a first continuous or discontinuous rim and a second closed structure having a second continuous or discontinuous rim, said first closed structure and said second closed structure connectable or integrally connected such that the first continuous or discontinuous rim is positioned above the second continuous or discontinuous rim, so as to allow said first continuous or discontinuous rim to serve as a fulcrum and said second continuous or discontinuous rim to serve as a prying lip.

According to embodiments of the invention, the first structure and the second structure comprise continuous or discontinuous annular rings.

According to embodiments of the invention, the first structure and the second structure comprise continuous annular rings.

According to an aspect of the present invention there is provided a method of opening a plurality of bottles comprising:
(a) placing said at least two outwardly facing bottle-opening structures of the bottle opener disclosed herein under the bottle crown-caps of at least two bottles; and

(b) lifting the bottom of the at least two bottles substantially simultaneously in an upwards direction so as to engage said at least two outwardly facing bottle-opening structures with the top of the bottle crown caps, thereby opening the plurality of bottles.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-D are different views of an exemplary dual bottle opener in accordance with some exemplary embodiments of the invention;

FIGS. 2A-D are different views of an exemplary dual bottle opener in accordance with some exemplary embodiments of the invention simultaneously engaging two bottles;

FIG. 3 is a view of an exemplary dual bottle opener in accordance with some exemplary embodiments of the invention;

FIGS. 4A-D are different views of exemplary components of a dual bottle opener, which when combined can generate a dual bottle opener in accordance with some exemplary embodiments of the invention;

FIGS. 5A-B are different views of an exemplary dual bottle opener in accordance with some exemplary embodiments of the invention;

FIGS. 6A-B are different views of an exemplary dual bottle opener in accordance with some exemplary embodiments of the invention;

FIGS. 7A-C are different views of an exemplary dual bottle opener in accordance with some exemplary embodiments of the invention simultaneously engaging two bottles; and

FIG. 8 is a photograph of an exemplary sheet of metal that can be used to manufacture the dual bottle opener.

FIGS. 9A-B are different views of an exemplary triple bottle opener in accordance with some exemplary embodiments of the invention capable of simultaneously engaging three bottles;

FIG. 10 is a view of an exemplary bottle opener in accordance with some exemplary embodiments of the invention capable of simultaneously engaging a plurality of bottles; and

FIG. 11 is a view of an exemplary dual bottle opener in accordance with some exemplary embodiments of the invention simultaneously engaging eight bottles.

### DESCRIPTION OF SPECIFIC EMBODIMENTS OF THE INVENTION

The present invention, in some embodiments thereof, relates to a bottle opener, methods of fabricating same and using same for opening at least two bottles concurrently, in opposing directions.

The bottle opener is particularly advantageous in a social setting (e.g., a party), whereby two users can open two bottles at the same time, optionally without directly touching the bottle opener itself, each user opening the bottle with a single opposing movement with the arm/hand that is used for grasping the bottle, in a fashion that somewhat mimics toasting. The bottle opener may be used in a drinking game, whereby the first user who manages to open his/her bottle with the opener, is the winner and optionally drinks the contents of the bottle (e.g. beer). The other participant or participants lose his/their drinking bottle, whilst functioning as a human bottle opener.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

According to a first aspect of the invention, there is provided a bottle opener, which comprises at least two outwardly facing bottle-opening structures that are connected to one another with a rigid connecting element.

In one embodiment, the bottle opener is a dual bottle opener which comprises a thin, relatively elongated body which includes a first bottle opening structure located towards one end and a second bottle opening structure located towards the opposite end.

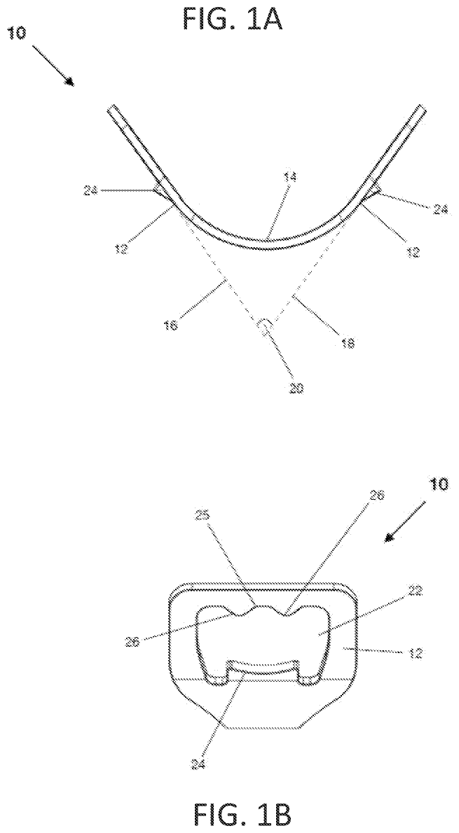

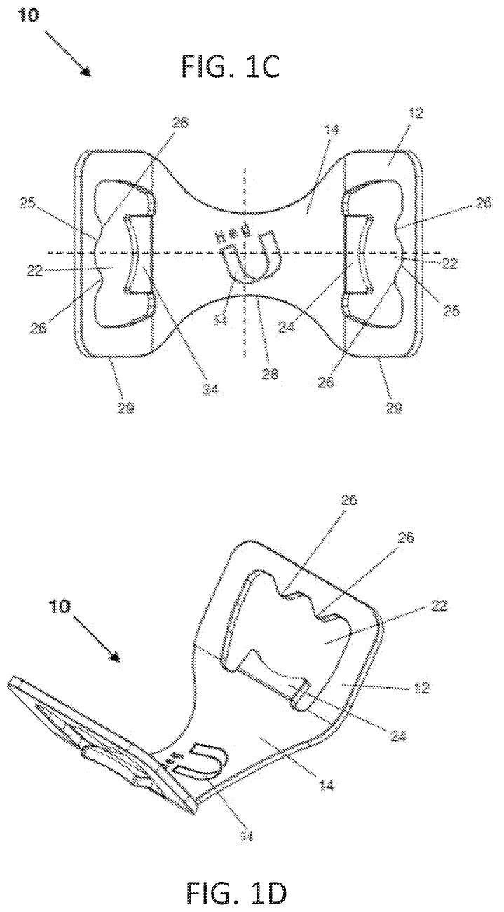

For purposes of better understanding some embodiments of the present invention, reference is now made to FIGS. 1A-D showing respectively a side, front, top and isometric view of an exemplary dual bottle opener according to embodiments of the present invention.

FIGS. 1A-D illustrate an exemplary dual bottle opener 10 comprising two opposing outwardly facing, bottle-opening structures 12.

The term “bottle opening structure” refers to a structure that may be used to remove a bottle top from a bottle. In one embodiment, the bottle opening structure is suitable for prying a crimped-on bottle cap (i.e., crown cap) off a bottle.

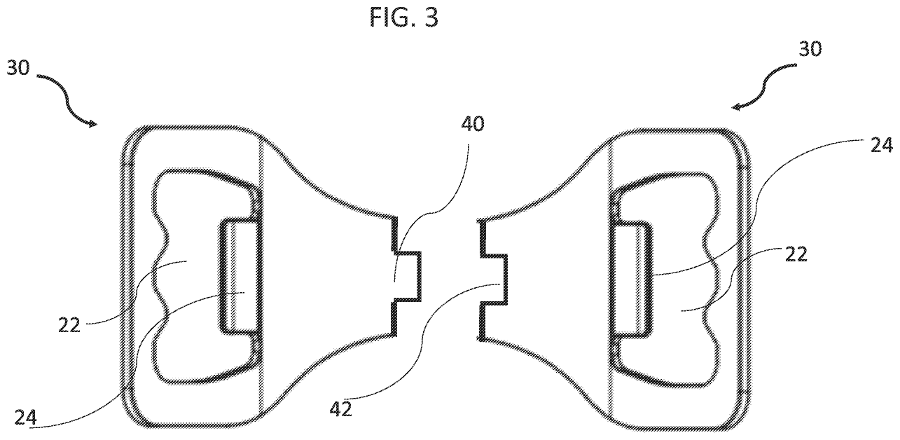

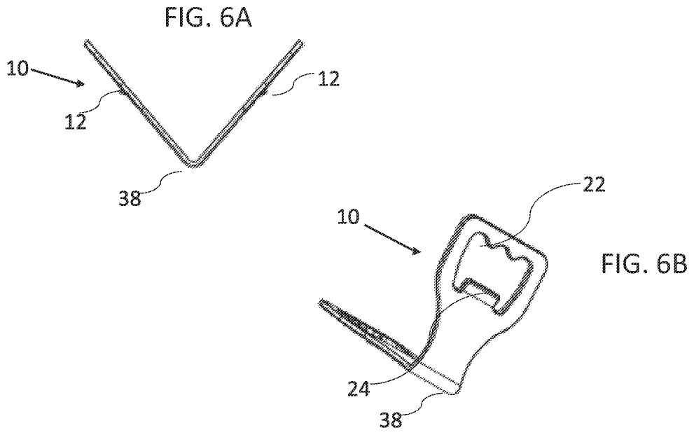

The two bottle-opening structures 12 are connected to each other via a rigid connecting element 14. In one embodiment, the rigid connecting element 14 is rounded or curved. The first opposing bottle-opening structure is on a first plane 16 and the second opposing bottle opening structure is on a second plane 18, the planes being non-parallel and intersecting at a predetermined angle 20, which is preferably between 50-85 degrees, and more preferably between 60-80 degrees, optionally about 70 degrees. The bottle opening structure 12 comprises an aperture 22, having a shape configured to open a bottle. In one embodiment, the bottle opening structure comprises a prying lip 24, which is configured to go under a bottle cap and a fulcrum 25, which is configured to have at least one point of contact 26 on the top of a bottle cap. The prying lip may be rounded as in FIGS. 1B-D or flat as shown in FIGS. 3 and 6B. The advantage of the rounded prying lip is that it can serve to grasp additional teeth of the crown cap (e.g. at least two, at least three or at least four).

In one embodiment, the prying lip edge has a beveled surface which extends rearwardly at an acute angle with respect to at least one of the top or the bottom surfaces of the opener whereby the opener may be slipped under a crown cap with the beveled surface.

FIG. 1B illustrates a bottle opening structure 12 wherein fulcrum 25 has two points of contact 26 with the top of a bottle cap. FIG. 1C illustrates an exemplary dual bottle opener 10 having a waist 28, the waist width being of narrower dimension than the width at the ends 29. The waist can be of different degrees or shapes of inward pinching, to facilitate anatomical characteristics of a user and the tool itself.

The bottle opener may further comprise a promotional branding or a design element 54. Such advertising or artwork can be cast into the opener, or applied using techniques such as pad printing or dye sublimation heat transfers, thus making the advertising available in color.

As illustrated in FIG. 1D, the connecting element 14 of the dual bottle opener is arcuate or bowed between its two ends. The bend in the connecting element ensures that the two opposing, outwardly facing bottle-opening structures are on different, non-parallel planes. The two opposing non-parallel planes intersect at a predetermined angle (for example between 50-85 degrees and more preferably between 60-80 degrees, more preferably about 70 degrees).

It will be appreciated that the first and the second bottle opening structure of a dual bottle opener of embodiments of the invention may be of any configuration so long as they can suitably open a bottle.

In one embodiment, the first bottle opening structure is identical to the second bottle opening structure. In this scenario, the bottle opener may be symmetrical about both its horizontal (x) and its vertical (y) axis (see for example FIG. 1C).

In another embodiment, the first bottle opening structure is non-identical to the second bottle opening structure.

In still another embodiment, the first bottle opening structure and the second bottle opening structure are configured to pry crown caps off a glass bottle.

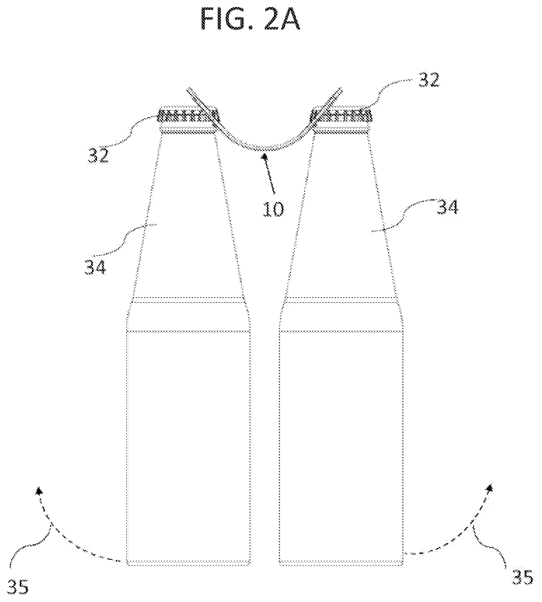

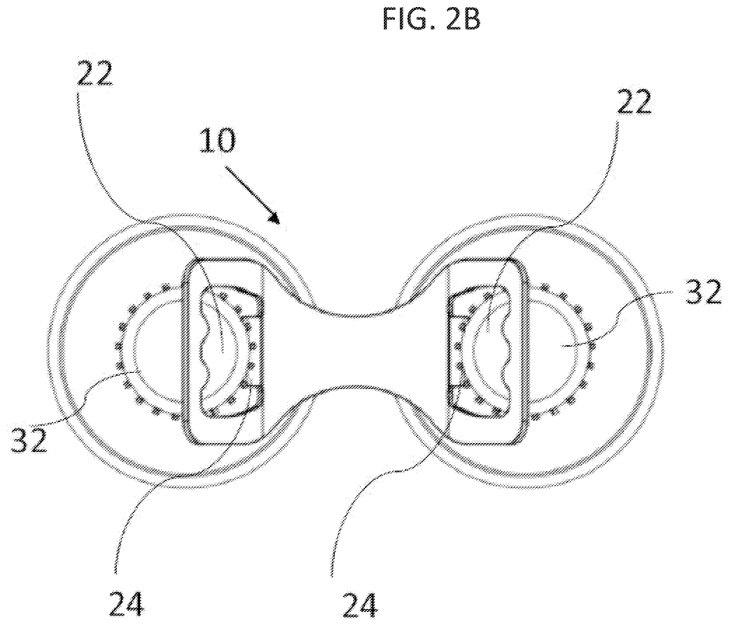

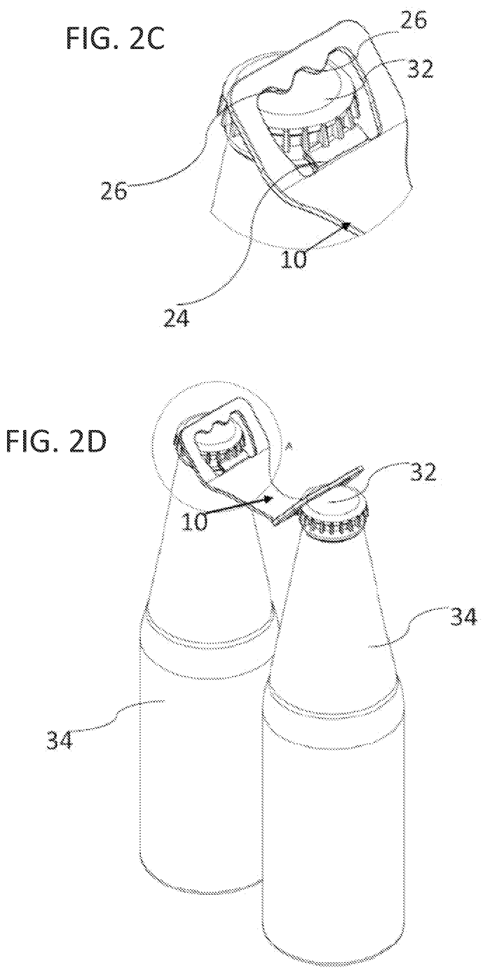

FIGS. 2A-D illustrate how a dual bottle opener 10 may be used to substantially simultaneously remove crown caps 32 of two bottles 34. The prying lip 24 of the opener is placed under the crown cap 32 of both the bottles 34. An upward movement of the bottles in opposite directions from each other 35 allows for engagement of the fulcrum and prying off of the bottle cap. It will be appreciated that the removal of the crown caps may also be carried out in a staggered manner, whereby the crown cap of the first bottle is removed prior to the removal of the crown cap of the second bottle. Furthermore, it will be appreciated that the bottle opener 10 may be utilized by a single user or two users (concurrently).

In one embodiment, the bottle opener is a dual bottle opener and the two outwardly facing bottle opening structures are opposing i.e., functionally opposing, whereby the first bottle opening structure may be activated by a bottle-lifting motion away from the center of the opener and towards a first user and the second bottle opening structure is activated by a bottle-lifting motion away from the center of the opener and towards the second user in the opposite direction, wherein the first user and the second user are standing opposite each other. It will be appreciated that the first user and the second user do not necessarily have to touch the bottle opener for purposes of opening the bottle, but rather move the arm which is grasping the bottle in an upward motion.

The bottle opener is suitable for holding in a user's hand, although it will be appreciated, that typically during activation, removal of the bottle tops is actually hands-free.

The bottle opener is portable (i.e., it is not fixed or immobilized onto a solid surface).

FIG. 3 illustrates another embodiment, whereby two bottle openers 30, each having a single aperture 22 are configured to be combined, whereby protrusion 40 of the first bottle opener 30 attaches to the receptacle 42 of the second bottle opener 30. At least one of the two bottle openers comprises a curved connecting element. In a particular embodiment, both the bottle openers comprise at least part of the curved connecting element.

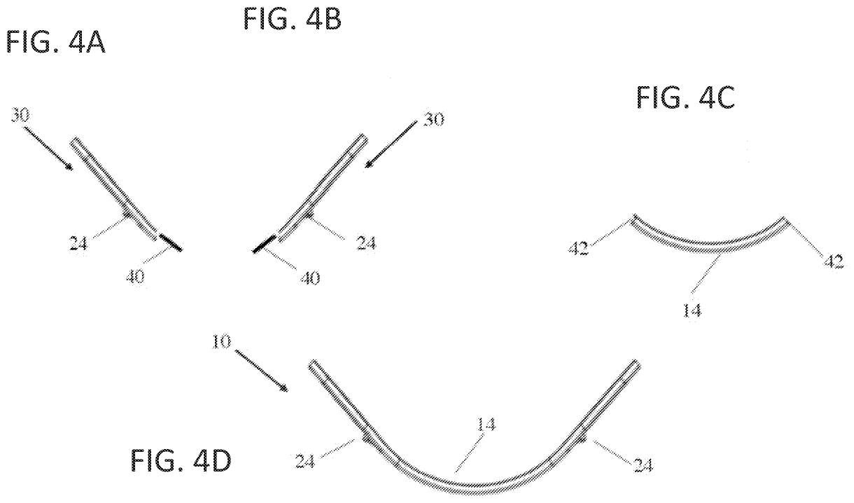

It will be appreciated that a dual bottle opener may be constructed from two standard single bottle openers (which do not comprise a curved element) wherein each of the single bottle openers are attached to a curved connecting element. The attachment may be by way of a clip, a button, a lever, a knob, a screw, a stud, a protrusion etc. This embodiment is illustrated in FIGS. 4A-D. FIG. 4A illustrates a first single bottle opener 30 having a bottle opening structure such as a prying lip 24. FIG. 4B illustrates a second single bottle opener 30 having a bottle opening structure such as a prying lip 24. FIG. 4C illustrates a curved connecting element 14. Each of the bottle openers 30 comprises a lever 40, said lever acceptable into a receptacle 42 formed in, or on, the rigid connecting element. In one embodiment, the lever 40 is a protrusion which slots into the receptacle 42. When the two single bottle openers 30 are connected with the connecting element 14, a dual bottle opener 10 is constructed (FIG. 4D).

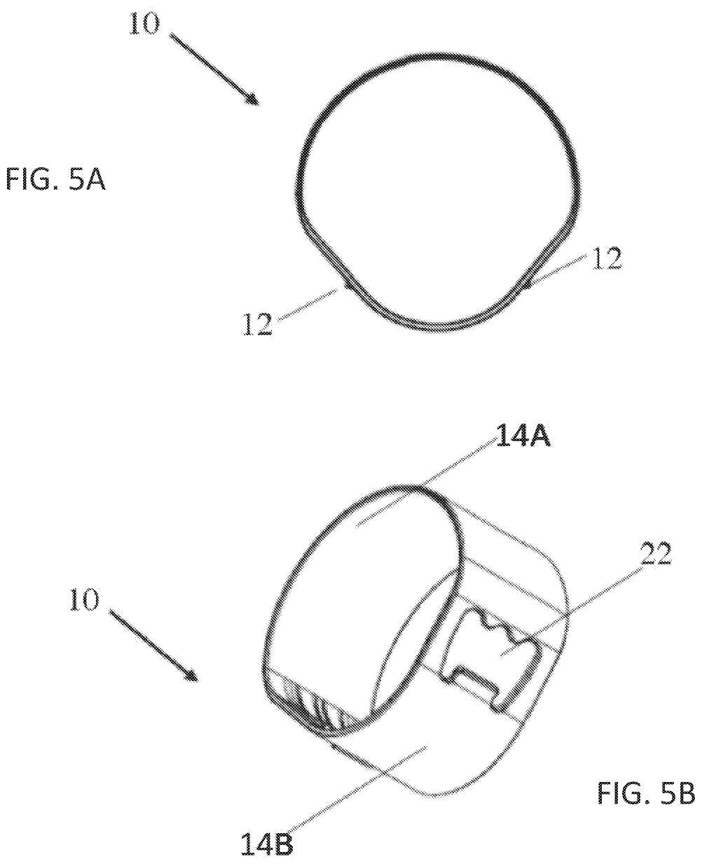

FIGS. 5A-B illustrate a dual bottle opener 10 according to embodiments of the invention whereby the opener is essentially circular. The two bottle opening structure are connected via a connecting element 14A on one half of the opener and a second connecting element 14B on the other half of the opener.

FIGS. 6A-B illustrate a dual bottle opener 10 according to embodiments of the invention whereby the two bottle opening structures 12 are connected via a V shaped connecting element 38. The angle of the V shaped may be between 50-85 degrees, preferably 60-80 degrees optionally about 70 degrees.

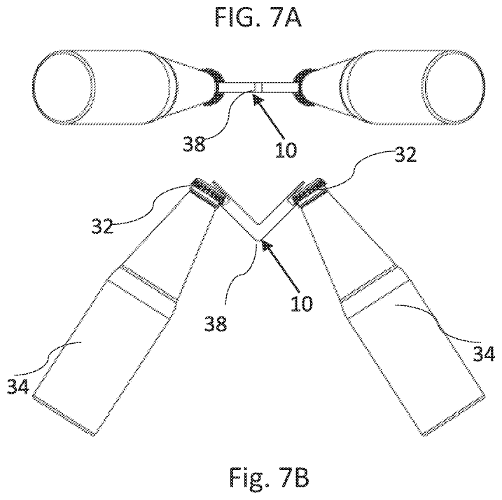

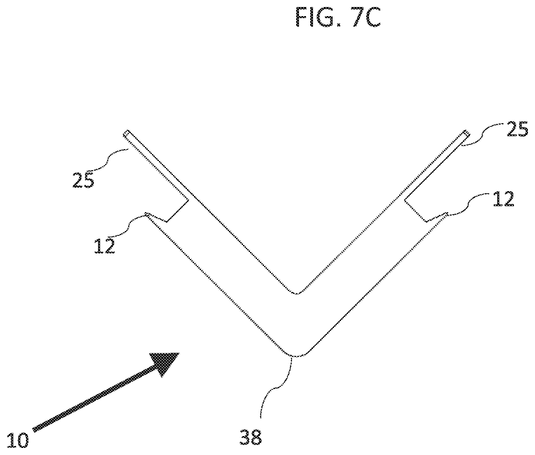

FIGS. 7A-B illustrate how the dual bottle opener 10 having a V shaped connecting element 38 may be used to substantially simultaneously remove crown caps 32 of two bottles 34 in a similar fashion as described for FIG. 2A.

FIG. 7C illustrates another embodiment of a bottle opening structure 12 wherein fulcrum 25 has a single point of contact with the top of a bottle cap.

The dual bottle opener conveniently has a length of about 3-30 cm. More specifically the horizontal distance between a distal end of the first opening structure and a distal end of the second opening structure is between 3 cm and 20 cm and more preferably between 3 cm-10 cm. In another embodiment, the horizontal distance between a distal end of the first opening structure and a distal end of the second opening structure is between 10 cm and 16 cm.

The thickness of the bottle opener is between 0.5 mm-4 cm, depending on the material from which it is being fabricated.

According to another embodiment, the bottle opener comprises three, four, five or six bottle opening structures being connected with an appropriate number of rigid connecting elements. In one embodiment, the bottle opener comprises at least one pair of opposing outwardly facing bottle opening structures.

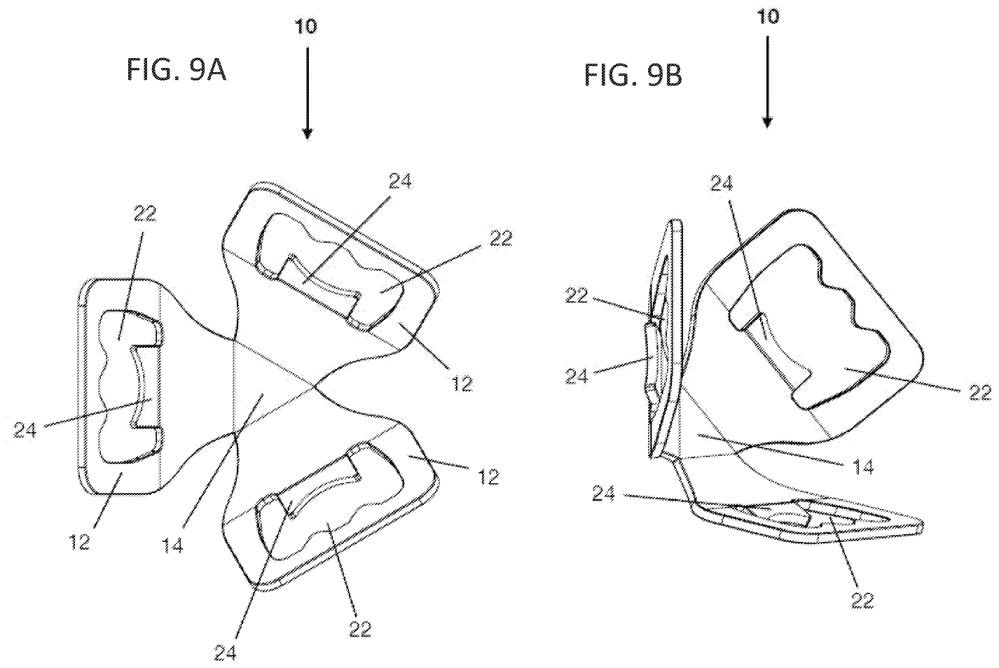

FIGS. 9A-B illustrates a bottle opener 10 which has three identical bottle opening structures 12, which are evenly spaced in relation to a central connecting structure 14. Each bottle opening structure comprises an aperture 22 and a prying lip 24. The bottle opening structures 12 are each on non-parallel planes.

In one embodiment, the bottle opener is a triple bottle opener and the three outwardly facing bottle opening structures are opposing i.e., functionally opposing, whereby the first bottle opening structure may be activated by a bottle-lifting motion away from the center of the opener and towards a first user, the second bottle opening structure is activated by a bottle-lifting motion away from the center of the opener and towards the second user, and the third bottle opening structure is activated by a bottle-lifting motion away from the center of the opener and towards the third user, wherein the first user, the second user and the third are standing in a group, facing one another.

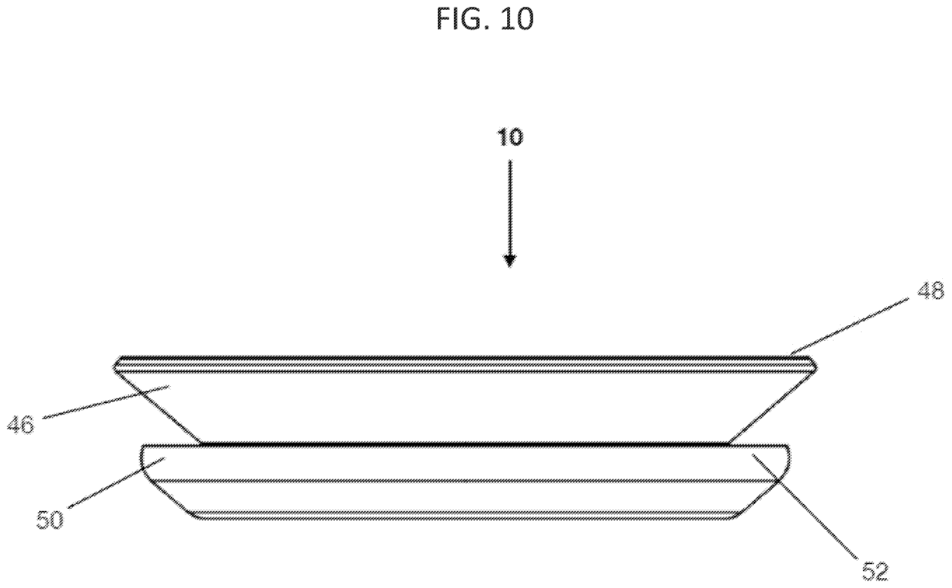

FIG. 10 illustrates a bottle opener 10 which is capable of substantially simultaneously opening a plurality of bottles—for example, 2, 3, 4, 5, 6, 7, 8. The opener comprises a first closed structure 46 having a first rim 48 and a second closed structure 50 having a second rim 52. The first rim 48 is positioned above the second rim 52. The first structure 46 is connected to the second structure 50 such that the first rim 48 serves as a fulcrum and the second rim 52 serves as a prying lip. Typically, the perimeter of the first rim 48 is greater than the perimeter of the second rim 52. An exemplary diameter of a circular (e.g. ring shaped) rim is between 10 cm and 20 cm. An exemplary angle of connection between the first structure 46 and the second structure 50 is about 40°.

In one embodiment, the first structure 46 and the second structure 50 are closed rings, although it will be appreciated that the present invention envisages any shape, square, rectangle, hexagonal etc. The first structure 46 and the second structure 50 may be annular or non-annular. Typically, the first structure has an identical shape as the second structure. The bottle opener according to this aspect of the present invention comprises a single prying lip and a single fulcrum which serves to open a plurality of bottles.

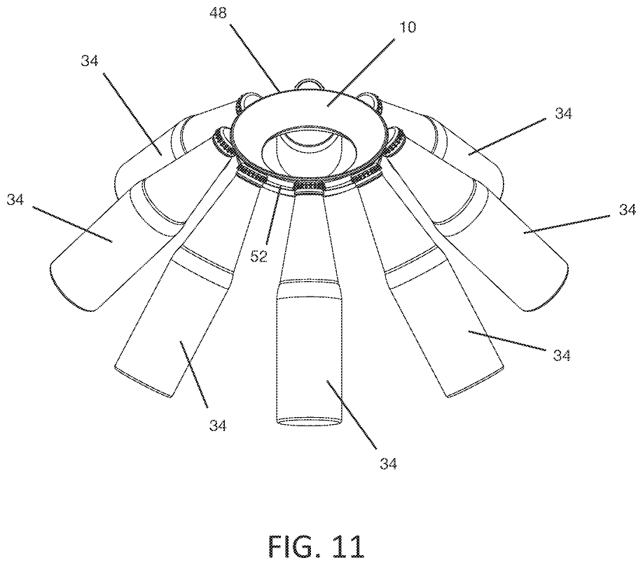

FIG. 11 illustrates how the bottle opener of FIG. 10 can be used to simultaneously open a plurality of bottles 34. A plurality of users stand in a group each holding a bottle. The bottle opener is in the center of the group and the users surround it. The bottles are opened by a bottle-lifting motion away from the center of the opener and towards each of the users. The bottom rim of the opener 52 is placed under the crown cap 32 of the bottle 34. The top rim of the opener 48 moves along the top of the crown cap 32 of the bottle 34 and serves as a fulcrum.

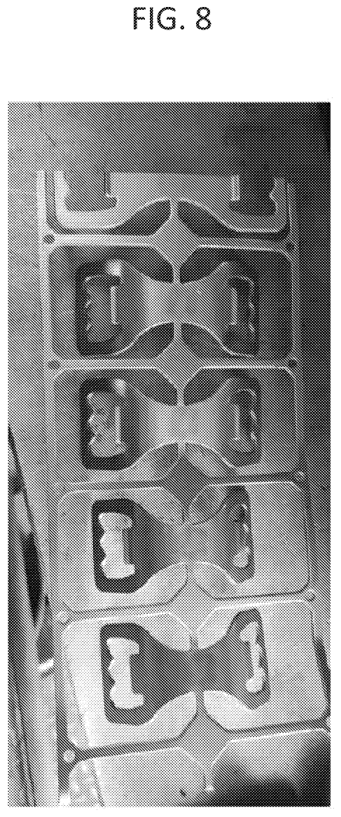

The opener may be formed from a metal sheet or from cast metal with stamping, injection molding and/or coining steps. Exemplary metals include, but are not limited to iron and stainless steel. The opener may be formed from other materials, such as a polymeric material, with other steps, such as a molding step, or 3D printing, as long as they are suitably stiff and rigid. According to a particular embodiment, the malleable metal blank is stamped, cut, or otherwise suitably formed from sheet metal stock with apertures disposed for defining the bottle opening structures (see for example, FIG. 8). Once cut, the prying lip can be bent using a press and the opener can be bent such that the two bottle opening structures are on different non-parallel planes.

However, the opener can also be manufactured from several pieces of metal or synthetic cast, welded or glued materials. It can also be produced by a combination of plastics and metal, wood and metal or cast metal or cast or injected synthetic material. In still another embodiment, the opener is made from wood. The opener can be covered and decorated with synthetic materials, plastics, metal, latex, rubber and be painted or treated, all to give it a different, modern, attractive, playful or professional aspect.

The bottle opener may be substantially smooth over its entire surface on both the top and bottom surfaces and may be considered an integrated single piece unitary device. In one embodiment, the prying edges of both bottle opening structures, and the bottle opening apertures are the only interruptions in the smooth surfaces. It will be appreciated the connecting element may also comprise a rough surface to allow for a non-slip friction. In another embodiment, the connecting element comprises a magnetic surface. In still other embodiments, the bottle opening structure comprises a magnetic surface such that the prying lip is further secured to the crown cap with a magnetic force.

While the present disclosure has been disclosed with reference to particular details of construction, these should be understood as having been provided by way of example and not as limitations to the scope or spirit of the disclosure. In particular, the precise cross sectional shape of the dual bottle opener 10 can be varied. The external configuration may be determined by any number of factors both aesthetic and functional. The centrally narrower or thinner part of the body facilitates the operation of the tool. The shape of the apertures may be varied. It will be understood that the shape of the exterior of the bottle opener 10 may be regular, smooth or irregular in cross section, square, or otherwise curved or straight.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A bottle opener comprising at least two outwardly facing bottle-opening structures being connected to one another with at least one rigid connecting element, said at least two outwardly facing bottle-opening structures being on different, non-parallel planes, wherein:
(a) the bottle opener comprise two outwardly facing, opposing bottle-opening structures and said different, non-parallel planes intersect at a predetermined angle between 50-85 degrees; and/or
(b) said at least two bottle opening structures are identical; and/or
(c) the bottle opener having mirror symmetry about its vertical and horizontal axis; and/or
(d) the bottle opener configured for substantially simultaneously removing crown caps from at least two hand-held glass bottles; and/or;
(e) each of said outwardly facing opening structures is designed for removing crown caps.

2. The bottle opener of claim 1, comprising two opposing facing bottle-opening structures configured for substantially simultaneously removing crown caps from two hand-held glass bottles.

3. The bottle opener of claim 2, wherein said removing is hands-free removing.

4. The bottle opener of claim 1, wherein said bottle opening structures comprise an aperture.

5. The bottle opener of claim 1, being a dual bottle opener comprising two opposing outwardly facing bottle-opening structures and a single rigid connecting element.

6. The bottle opener of claim 5, configured for being operable concurrently by two users, wherein a first of said two users removes a crown cap from a first of said two glass bottles and a second of said two users substantially simultaneously removes a crown cap from a second of said two glass bottles, whereby said two users need not directly touch the dual bottle opener.

7. The bottle opener of claim 5, wherein said connecting element:
(i) comprises a bend;
(ii) is V shaped or U shaped;
(iii) is an open U shape; or
(iv) a closed ring shape.

8. The bottle opener of claim 5, wherein each of said bottle-opening structures form a fulcrum at one end thereof and a prying lip at the opposite end thereof.

9. The bottle opener of claim 8, wherein said fulcrum of a first bottle-opening structure of said two outwardly facing bottle-opening structures and a fulcrum of a second bottle-opening structure of said two outwardly facing bottle-opening structures is positioned at the distal ends of said connecting element.

10. The bottle opener of claim 1, wherein said at least two outwardly facing bottle-opening structures are integrally formed with said at least one rigid connecting element.

11. The bottle opener of claim 1, wherein said at least two outwardly facing bottle-opening structures are connectable to said at least one rigid connecting element.

12. The bottle opener of claim 11, wherein each of said at least two outwardly facing bottle-opening structures form a part of a bottle opener which further comprises a lever, said lever acceptable into a receptacle formed in or on said at least one rigid connecting element.

13. The bottle opener of claim 8, wherein said different planes are selected such that when a bottom of said first bottle is pivoted upwardly, the fulcrum of said first notch engages, and extends partially across, the top surface of the first crown cap and when a bottom of said second bottle is pivoted upwardly, the fulcrum of said second notch engages, and extends partially across, the top surface of the cap of the second bottle

14. The bottle opener of claim 1, being fabricated from metal.

15. The bottle opener of claim 8, wherein said prying lip is rounded.

16. The bottle opener of claim 1, being formed by at least one of a stamping process, a casting process, a forging process, a machining process, an additive manufacturing process, or any combination thereof.

17. A bottle opener for substantially simultaneously removing crown caps from at least two hand-held bottles, the opener comprising a first closed structure having a first continuous or discontinuous rim and a second closed structure having a second continuous or discontinuous rim, said first closed structure and said second closed structure connectable or integrally connected such that the first continuous or discontinuous rim is positioned above the second continuous or discontinuous rim, so as to allow said first continuous or discontinuous rim to serve as a fulcrum and said second continuous or discontinuous rim to serve as a prying lip.

18. The bottle opener of claim 17, wherein said first structure and said second structure comprise continuous or discontinuous annular rings.

19. The bottle opener of claim 18, wherein said first structure and said second structure comprise continuous annular rings.

20. A method of opening a plurality of bottles comprising:
(a) placing said at least two outwardly facing bottle-opening structures of the bottle opener of any one of claims 1-16 under the bottle crown-caps of at least two bottles; and
(b) lifting the bottom of the at least two bottles substantially simultaneously in an upwards direction so as to engage said at least two outwardly facing bottle-opening structures with the top of the bottle crown caps, thereby opening the plurality of bottles.
